(19) United States
(12) Patent Application Publication
(10) Pub. No.: US 2012/0239435 A1
(43) Pub. Date: Sep. 20, 2012

(54) AUTOMATED ANNOTATION OF CLINICAL DATA

(75) Inventors: Colleen M. Ennett, White Plains, NY (US); Pradyumna Dutta, Croton-on-Hudson, NY (US)

(73) Assignee: KONINKLIJKE PHILIPS ELECTRONICS N.V., EINDHOVEN (NL)

(21) Appl. No.: 13/512,356

(22) PCT Filed: Nov. 17, 2010
(86) PCT No.: PCT/IB10/55240

§ 371 Date: May 29, 2012

Related U.S. Application Data
(60) Provisional application No. 61/285,215, filed on Dec. 10, 2009.

(51) Int. Cl. G06Q 50/24

(52) U.S. Cl. 705/3

(57) ABSTRACT

When annotating a patient's medical or clinical record, an automated annotation system compares aggregated patient data (e.g., historical vital sign data, lab results, patient admission/discharge/transfer information, etc.) and matches events and/or patterns therein to procedure profiles to determine whether a given procedure is required, in progress, or completed. If the probability of procedure necessity or occurrence is above a predetermined threshold, then system inserts an annotation into the clinical record to mitigate a need for a clinician to manually enter the annotation. Alarm parameters are adjusted to reflect a physiological response to the determined procedure, to reduce false alarm triggers. Additionally or alternatively, triggered advisories may be suppressed from the user interface for a time period during which conditions specified in the procedure profile exist, or for a specific period of time following the procedure. In another embodiment, triggered advisories that occur under the specific conditions identified in a procedure profile may be flagged in the patient's medical record with a notification that the suspected procedure is being performed.

### DESCRIPTION

The present application finds particular utility in medical record data systems. However, it will be appreciated that the described technique(s) may also find application in other types of data recording systems, other medical systems, and/or other record annotation applications.

Annotation of medical data involves adding explanatory notes to the medical data, such as data automatically collected from patient monitoring systems and stored on a central station. The annotation, or explanatory note, identifies a medical procedure, finding, medicine administered, observation, or other relevant information that is entered by a care provider. Annotations are useful for treatment, billing, administrative, and legal purposes, as well as for research purposes. However, annotation is a manual process that is time-consuming, labor-intensive, and expensive. Furthermore, the language choice and abbreviations often vary with the annotator, making interpretation and searching difficult.

The classical approach to medical data annotation is manual annotation by a clinical expert. Manual annotation can either be done at the time that an event occurs or a procedure is performed, or it can be done retrospectively. Even when manual annotation is performed in real-time, these notations are usually done in the form of free-text or semi-structured notes, which may or may not have a time-stamp associated with them. A time-stamp may indicate the time that an event occurred, or it may indicate the time that the event was recorded. Parsing these types of notes is difficult, because of the occurrence of typographic errors, unique abbreviations, and incomplete sentences. If the notes are a summary of the events that occurred during the previous time period, the time-stamp which indicates when the note was recorded may not specifically represent when the events occurred. Retrospective manual annotation requires a clinical expert to review the patient's paper or electronic medical record, and cross-reference the nursing notes, laboratory orders, laboratory results, admission data, discharge data, transfer data, and any other relevant piece of data. Then the clinical expert makes a note in the record. Manual retrospective annotation can be prohibitively expensive, and as a result it is rarely done.

There are several drawbacks to using data without medical data annotation. For instance, benign, temporary changes in physiological parameters caused by routine clinical procedures invoke false positive alarms in patient monitoring devices. False values and erroneous values trigger false positive alerts in patient monitoring devices and add to the burden of information overload for clinicians. Without medical data annotation, it is difficult to distinguish between temporary changes in patient health indicators caused by ongoing clinical procedures and changes indicative of deterioration in the patient's health. Accurate annotations are important when analyzing retrospective data and when working with real-time clinical data to devise accurate physiological models and prediction algorithms to identify clinical events. Lack of annotated data for clinical and research purposes hinders clinicians and researchers from potentially achieving improved clinical outcomes. Furthermore, without properly annotated data, it is difficult to automatically determine the extent to which a clinical practice guideline has been executed, which hinders the implementation of computer-executable clinical practice guidelines and protocols.

There is an unmet need in the art for systems and methods that facilitate automated annotation of patient medical data, and the like, thereby overcoming the deficiencies noted above.

In accordance with one aspect, a system that facilitates automated annotation of clinical data includes a charting database that includes historical patient vital sign information, an admission-discharge-transfer (ADT) database that stores patient information related to patient admission, discharge and transfer to and from healthcare facilities, and a laboratory database that stores patient laboratory test result information. The system further includes a procedure profiles system with a processor that executes computer-executable instructions stored in a computer-readable medium, the instructions including aggregating patient data from one or more of the charting database, the ADT database, and the laboratory database. The instructions further include matching patterns of events in the aggregated patient data that are defined in one or more procedure profiles, and determining a probability that a clinical procedure is required, is in progress, or has been completed, as a function of the matched events. Additionally, the instructions include annotating the patient's clinical record to indicate that the procedure is required or has been performed if the probability is above a predetermined threshold, and storing the annotated patient clinical record to a computer-readable medium.

In accordance with another aspect, a method of automatically annotating clinical patient data includes aggregating patient data from one or a plurality of sources, matching patterns of events in the aggregated patient data that are defined in one or more procedure profiles, and determining a probability that a procedure is required, is in progress, or has been completed, as a function of the identified events. The method further includes annotating the patient's clinical record to indicate that the procedure is required or has been performed if the probability is above a predetermined threshold.

In accordance with another aspect, a method of generating procedure profiles for annotating clinical patient data includes identifying clinical procedures for which profiles are desired, defining procedure profile parameters for the identified procedures, and identifying observable elements in the procedure profile parameters. The method further includes testing one or more procedure profiles using a retrospective clinical database in order to validate the one or more procedure profiles, and storing the one or more procedure profiles to a procedure profile database.

One advantage is that false alarms are reduced.

Another advantage resides in automated clinical record annotation.

Another advantage resides in time savings for clinicians.

Another advantage resides in facilitating data mining and record searching.

Still further advantages of the subject innovation will be appreciated by those of ordinary skill in the art upon reading and understanding the following detailed description.

The drawings are only for purposes of illustrating various aspects and are not to be construed as limiting.

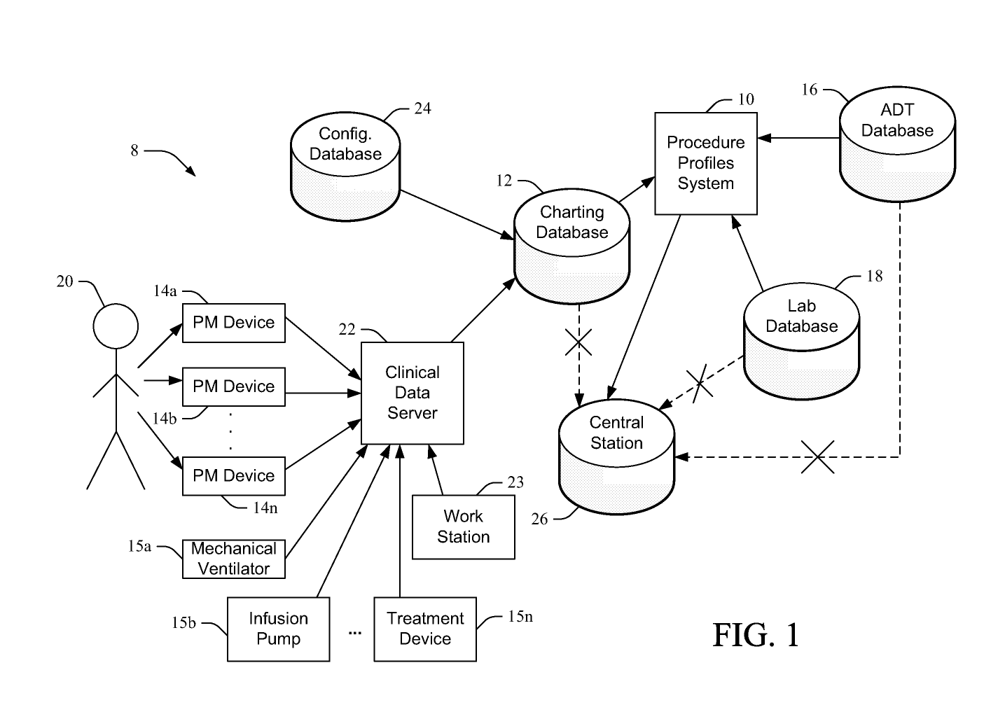

FIG. 1 illustrates procedure classification system for automatically documenting in a clinical record when data are associated with a particular clinical procedure or protocol that temporarily alters physiological data and equipment settings.

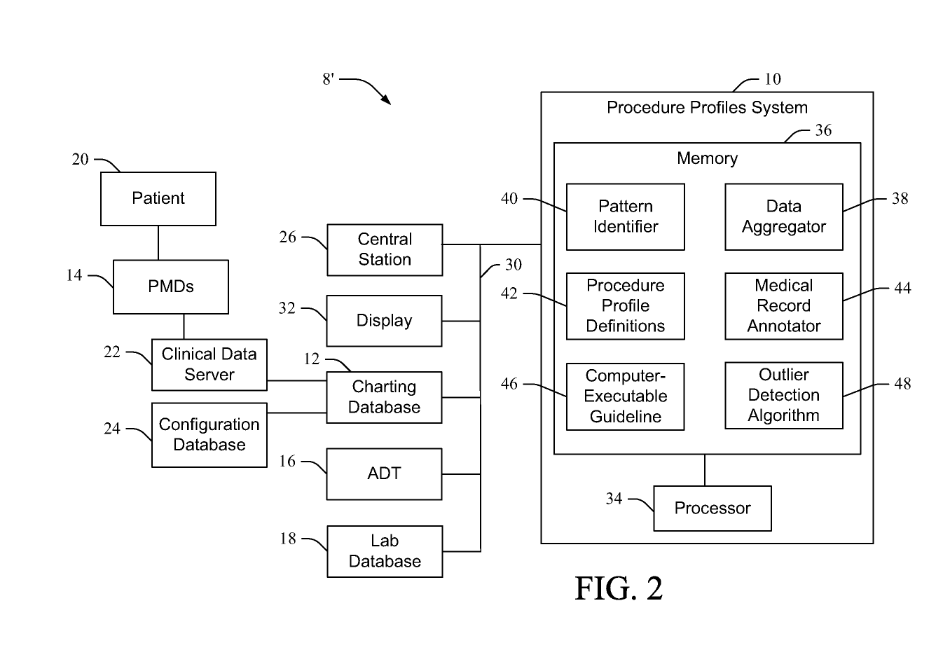

FIG. 2 illustrates another embodiment of the system in which the Procedure Profiles System (PPS) is described in greater detail.

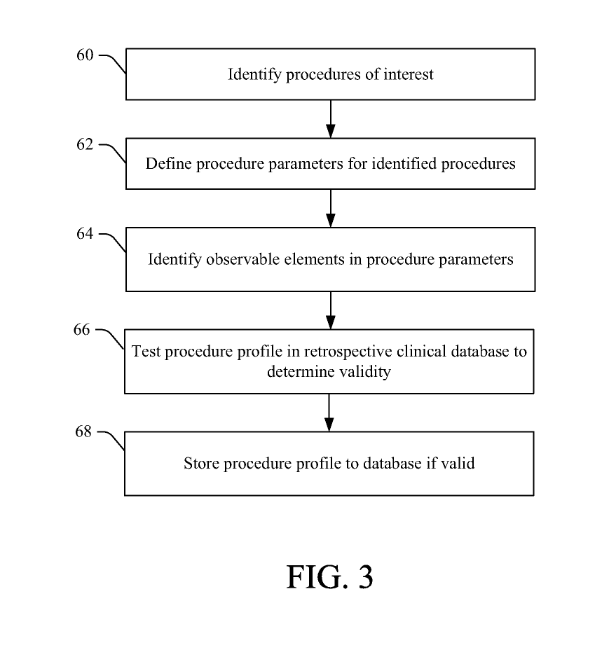

FIG. 3 illustrates a method of generating procedure profile definitions, in accordance with various aspects described herein.

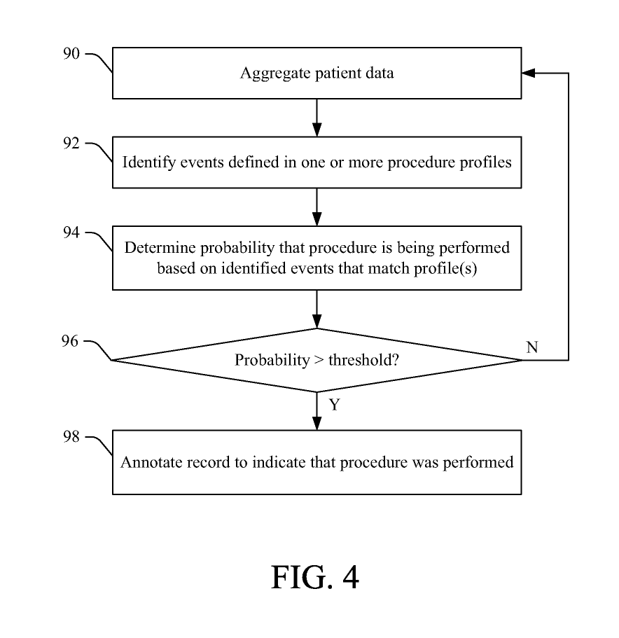

FIG. 4 illustrates a method for real-time implementation of the procedure profiles system, in accordance with various aspects set forth herein.

FIG. 1 illustrates the procedure classification system 8 for automatically documenting in a clinical record when data are associated with a particular clinical procedure or protocol that temporarily alters physiological data and equipment settings. The system uses Procedure Profile definitions to classify a sequence of clinical data as a clinical procedure or protocol.

The classification system 8 includes a procedure profiles system (PPS) 10 that receives patient information from several sources, including but not limited to: a charting database 12 that stores data from a data server 22 and a configuration database 24; an ADT (Admission/Discharge/Transfer) system 16 that contains patient demographic information, medical history information, etc.; and a Laboratory system 18 that contains the results of laboratory tests performed on patients 20. In another embodiment, the information sources include a computerized physician order entry (CPOE) system (not shown), which is used for entering medication and/or intravenous fluid orders and the like, as well as any other suitable information source.

FIG. 1 thus shows a patient 20 connected to multiple patient monitoring devices 14 that record, e.g., heart rate, respiratory rate, blood pressure, etc. The patient monitoring devices 14 may include an electrocardiogram (ECG), invasive or non-invasive blood pressure measuring devices, among others. Treatment devices 15 can include a mechanical ventilator 15a, an infusion pump 15b, or any other suitable device 15n for administering a treatment to a patient. The patient monitoring devices 14 and treatment devices 15 connect to a clinical data server 22 that receives and temporarily stores the data from the monitoring devices. A work station 23 is additionally coupled to the clinical data server 22, and a user enters manual treatment information such as injections or oral administration of a medicine to the patient. A configuration database 24 contains the definitions of the attributes and limits for each feature, e.g., heart rate: low=60, high=100. The raw data from the clinical data server 22 is matched to the definitions in the configuration database 24, and the resulting information is stored in the charting database 12. Additionally, advisory algorithms for the patient monitoring data are stored in the charting database.

A central station 26 collects data from the charting database 12, as well as the ADT system 16 (which includes demographic data, and admission, discharge and transfer data) and the laboratory system 18 that stores the results of lab tests that were ordered by the care provider, such as ABGs (arterial blood gases) or the like. In a classical scenario without the PPS 10, the central station 26 would aggregate the data from the charting database, the ADT system and the lab system for presentation to the user, as indicated by the dashed arrows with an X, and the user would be left to manually discern patient procedure progress. When the PPS 10 is implemented, the data from the charting database 12, the ADT system 16, and the laboratory system 18 would be pre-processed in the PPS 10 prior to being sent to the central station 26.

FIG. 2 illustrates another embodiment of the system 8′ in which the PPS 10 is described in greater detail. The system 8′ includes the PPS 10, which is coupled, by a bus 30 (e.g., wired or wireless), to each of the charting database 12, the ADT 16, the lab database 18, and the central station 26. Optionally, the PPS 10 is coupled to a display 32 that presents information to a user. The charting database 12 is further coupled to the clinical data server 22 and the configuration database 24. The clinical data server 22 receives information from one or more patient monitoring devices (PMDs) 14 and treatment devices 15, which in turn are coupled to the patient 20.

The PPS 10 includes a processor 34 that executes, and a memory 36 that stores computer-executable instructions for performing the various functions, methods, techniques, etc. described herein. The memory 36 stores received data from the clinical data server 22 (via the charting database 12), the ADT 16, and the lab system 18, as well as a number of computer-executable algorithms (e.g., computer-executable instructions for execution by the processor 34, and persistently stored in the memory 36). The processor 34 executes a data aggregation algorithm 38 that aggregates the data. In this sense, the processor 34 acts as a data pre-processor. The processor 34 then executes a pattern matching algorithm 40 that compares the aggregated data to stored profile definitions 42 and searches for patterns in the data that indicate which procedure was performed on specific patients. Upon discovering a match, the processor 34 executes a medical record annotation algorithm 44 to automatically annotate the patient's medical record to indicate that the procedure that was performed. Once the procedure is identified, the expected physiological response is looked up, e.g., the blood pressure may be expected to drop by 10%, and not recover for half an hour. The thresholds for triggering advisories are adjusted accordingly. This step filters out unnecessary advisories identified by the advisory algorithms in the charting database, and prevents unnecessary alarms from being triggered at the central station 26. In another embodiment, the triggered advisories are suppressed from the user interface for the period of time during which the specific conditions exist, or for a specified time frame following the event. In still another embodiment, when triggered advisories occur under the specific conditions identified in a procedure profile, the advisories are flagged with a notification that the suspected procedure is being performed, and is recorded in the patient's medical record. According to an example, after aggregating the data from the three sources, the PPS 10 searches for patterns in the database that match Procedure Profile definitions 42, and automatically annotates the patient's medical record (e.g., in the charting database) to indicate which procedure(s) was performed. The system 10 then sends the aggregated information to the central station 26 for use by the clinical caregivers. In addition to automatically annotating clinical data for accurate documentation of a clinical visit, another advantage of the system is that it filters out unnecessary advisories identified by the advisory algorithms in the charting database, and prevents them from being triggered at the central station. The result is fewer false positive alarms from patient monitoring devices, a more detailed and accurate patient record, and relevant clinical information transformed into a computer-interpretable format that can be used for automated clinical decision support systems and computer-executable clinical guidelines and protocols.

As mentioned above, the system includes the processor(s) 34 that executes, and the memory 36 that stores, computer executable instructions for carrying out the various functions and/or methods described herein. The memory 34 may be a computer-readable medium on which a control program is stored, such as a disk, hard drive, or the like. Common forms of computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor 34 can read and execute. In this context, the system 8 may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

With continued reference to FIGS. 1 and 2, the procedure profile definitions 42 define procedures that are performed on patients as a function of data collected before, during and/or after the procedures. Thus, when data collection patterns match a particular procedure profile, the system deduces that the procedure has been performed on the patient and annotates the patient record appropriately. This feature allows the system 8 to classify a sequence of clinical data as a clinical procedure or protocol. The method results in automatically documenting the procedure the clinical record when data are associated with a particular clinical procedure or protocol.

Several manners of classifying a sequence of clinical data are contemplated. One such approach is automated identification of clinical procedures. In this scenario, certain sequences or changes in the patient clinical data record are associated with particular clinical events, such as particular clinical procedures or deterioration of patient status. The procedure profiles in this case act as templates of such changes to define whether certain clinical events have occurred and to automatically annotate (e.g., record) these events in the patient data record.

According to an example of automated identification, temporary changes in physiologic values and equipment settings related to clinical procedures are identified by the processor 34 when executing the pattern identifier algorithm 40. For instance, clinical procedures often require a clinician to temporarily alter the equipment settings for a patient, which in turn temporarily impacts the patient's physiologic parameters. Other changes are insidious or could indicate deterioration in the patient's health status. Using procedure profile definitions for various sets of specific equipment setting changes and the ensuing effects on the patient's vital signs and laboratory values, the pattern identifier 40 automatically infers if a procedure has taken place, and the identity of the procedure. In this manner, benign changes in patient values resulting from routine clinical procedures are identified. Clinicians subconsciously perform this same process each time they review a patient's data in the context of recent procedures performed on the patient. If the clinician knows that a particular procedure was recently performed that is known to impact specific physiological values, the clinician will take account of this data when determining the appropriate clinical strategy to treat the patient. In this fashion, detection and classification of procedures are performed based on changes in the patient's data and settings on the patient monitoring equipment, and are stored in the patient's clinical record in a computer-interpretable way to provide valuable information required for clinical decision support.

According to another example of automated identification, improved continuity of care is achieved by providing a mechanism to quickly and easily record and communicate information from one health care provider to the next. Clinicians often dictate clinical notes into an audio recording system after the interacting with a patient. These notes may be processed (either manually or via a natural language processor) at a later point in time, and as such are not immediately available for review by other care providers. To overcome this deficiency in classical systems, the processor 34, by executing the pattern identifier 40, automatically recognizes a series of events as a particular procedure based on the procedure profile definitions 42, and creates an explanatory note associated with a time stamp to record the procedure. Optionally, this explanatory note can be displayed to an attending or responsible clinician for verification. If a clinician chooses to add clinical notes, dictated notes can be processed to text by a voice recognition system, retained as an audio file, transcribed or the like, and saved as an annotation to the record. The automatically annotated data provides information about the context in which the physiological parameters and equipment settings changed. This information can then be shared amongst all providers who care for a particular patient. By annotating patient data accurately as care progresses, an assurance is made that all care providers are quickly apprised of contextual data in the patient's medical information as care transfers from one provider to the next.

Another manner of classifying a sequence of clinical data involves identifying erroneous values. Inconsistencies in medical data that result from erroneous values, such as typographical errors when manually recording information, errors caused by changes in the patient's position and movement, as well as errors caused by faulty or poor connections, can make automated clinical decision support difficult to achieve. These erroneous values can result in apparently valid but unlikely patient data values, which would be ignored or overlooked by a clinician when considering the patient's health status. The measured parameters during the procedure can be flagged by the pattern identifying algorithm 40 so they are differentiated from true values, and can easily be filtered out before processing the data through a clinical alert engine (not shown). Optionally, annotations based on the data without the unlikely values can be noted as probable but not certain. Differentiation of clinically relevant values from false or erroneous values improves the reliability of the recorded data, which reduces false alarm rates in patient monitoring systems.

A third manner of classifying a sequence of clinical data involves identifying a guideline node. For example, if a patient is being treated for a disease for which there exists a clinical protocol or guideline, the processor 34 identifies a current node (location) of the patient in the clinical guideline. As intelligent clinical decision support systems evolve, it is valuable to have a method for recognizing patterns of events to automatically identify when a procedure has been completed. This information can be used to determine where a patient is in the clinical guideline. The automated identification of the current location of a patient in a clinical guideline facilitates following a patient with a computer-executable guideline 46. The computer-executable guideline 46 is used to provide decision support based on clinical guidelines and protocols (evidence-based recommendations), and improves adherence to the clinical guidelines and protocols in actual practice. In classical systems, limited amounts of this information are available in text-based nursing notes (or discharge summaries when considering a retrospective data review), which are not easily accessible to computers that process data through a clinical alerts engine. With respect to laboratory tests, for example, the timing of the availability of the test result may occur many hours or days after a procedure is performed, and as such may not be very useful for updating a position of the patient in the clinical practice guideline in real-time. By recognizing a series of events as a single procedure and annotating the data, this information can be easily accessible to a computer-executable guideline system.

The system 8 distinguishes between erroneous values, true values, and false values resulting from procedures and protocols performed on patients using the procedure profile definitions 42. Each procedure profile definition 42 comprises a description of which physiological values and equipment settings are affected during and/or following a particular clinical procedure or protocol. The description is derived from medical experts, clinical practice guidelines and protocols, and clinical literature, and includes a set of variables and a range of values for each variable. The system 8 optionally includes an outlier detection algorithm 48 based on clinically-relevant data ranges and patient profiles (i.e., based on the patient's demographics, current health status, past interventions, existing conditions, etc.).

The procedure profile definitions 42 include various levels of evidence to identify procedures and protocols to recognize that a set of events and conditions actually represents a single event, including, but not limited to: a definitional level, wherein a specific event or set of specific events must occur if a particular procedure or protocol was performed; an associated level, wherein a specific event or set of specific events may occur in addition to the conditions at the definitional level if a particular procedure or protocol was performed; and a precursor level, wherein a specific event or set of specific events may occur prior to the initiation of the procedure or protocol.

FIG. 3 illustrates a method of generating procedure profile definitions, in accordance with various aspects described herein. At 60, procedures and protocols of interest are identified. At 62, procedure parameters are defined. Such parameters may include without being limited to: circumstances under which the procedure is used; equipment settings that need to be changed for the procedure; expected impact on patient physiological values, including event pre-cursors that would signal to the care provider that a procedure should be performed, events that occur during the patient preparation for the procedure, events that occur during the procedure, and events that are expected after the procedure.

At 64, elements are identified that describe the profile and that are measured or observed and recorded (e.g., blood pressure, heart rate, or other measurable or observable parameters). According to one example, the definitions of the procedure profiles are determined by hypothesizing the conditions (variables and ranges of their values) that necessitate the procedure based on clinical knowledge by reviewing published clinical practice guidelines and protocols developed by experts, which are based on evidence from clinical trials and expert opinions, or by interviewing physician experts to develop a list of variables and their ranges. Additionally or alternatively, relevant variables are discovered that are affected by a particular procedure or protocol using data analysis techniques on a database of patients. Optionally, a guided discovery of procedure profiles is performed on a procedure profile database, e.g., by performing weighted searches of the database. Such a process may involve an interface that allows a user to specify a procedure profile and search the database for matches. The interface allows the user to select a subset of variables and to assign weights to convey their degree of importance in the profile. The user is able to save and retrieve previous profiles. The interface responds with immediate feedback on the number of instances in a database that match the suggested profile, and these instances can be confirmed by manually reviewing clinical notes.

At 66, the procedure profile definition is tested in a retrospective clinical database to validate it. At 68, the procedure profile is stored to the procedure profile database, if valid.

According to an example, the following example of a procedure profile, entitled “Endotracheal suctioning of mechanically ventilated adults and children with artificial airways,” is developed using a publicly-available published clinical practice guideline from a professional respiratory association. The guideline is used when it is necessary to remove pulmonary secretions from a patient being mechanically ventilated. The profile parameters are shown below in Table 1.

TABLE 1
Endotracheal Suctioning Procedure Profile organized according to the flow of events in time.

| | | | Expected changes | |
|---|---|---|---|---|
| | | | on physiological | |
| Stage | Event | Changes in equipment settings | values | Level |
| Requirements | Patient must be on a | Recorded measurements that | N/A | Definitional |
| | mechanical ventilator | indicate a patient is on a | | |
| | | ventilator, including ventilator | | |
| | | settings (ventilator mode, tidal | | |
| | | volume setting, respiratory | | |
| | | rate setting, PEEP setting, | | |
| | | etc.), ventilator start/end | | |
| | | dates, etc. | | |
| Precursors | Increased peak inspiratory | None | If volume- | Precursor |
| | pressures during volume- | | controlled | |
| | controlled mechanical | | mechanical | |
| | ventilation | | ventilation, ↑PIP | |
| | Decreased tidal volume | None | If pressure- | Precursor |
| | during pressure-controlled | | controlled | |
| | mechanical ventilation | | mechanical | |
| | | | ventilation, ↓Vt | |
| | Deterioration of arterial | None | ↓PaO2 | Precursor |
| | blood gas values | | | |
| | Increased work of | None | ↓Cdyn or ↑airway | Precursor |
| | breathing | | resistance | |
| Patient | Hyperoxygenation by | FIO2 setting set to 1.0 | ↑SpO2 or ↑SaO2 | Definitional |
| preparation | delivery of 100% oxygen | | | |
| | for >30 seconds prior to | | | |
| | suctioning event | | | |
| | Hyperventilation | ↑respiratory rate setting | ↑RR | Associated |
| | Hyperinflation | ↑tidal volume setting | ↑Vt (Observed) | Associated |
| | Hyperinflation | Manually trigger preset sigh | ↑Vt (Observed) | Associated |
| | | breaths on mechanical | | |
| | | ventilators that are equipped | | |
| | | with a sigh feature | | |
| | Initiation of use of pulse | Initiation of SpO2 | SpO2 | Associated |
| | oximeter to assess | measurements that last the | measurements | |
| | oxygenation during and | duration of the procedure | recorded only for | |
| | following procedure | | duration of | |
| | | | procedure | |
| | Instillation of normal saline | Initiation of normal saline drip | Dosages recorded | Associated |
| | through artificial airway to | | for normal saline | |
| | dilute and mobilize | | | |
| | pulmonary secretions | | | |
| Follow-up | Hyperoxygenation by | FIO2 setting set to 1.0 | ↑SpO2 or ↑SaO2 | Associated |
| care | delivery of 100% oxygen | | | |
| | for >60 seconds prior to | | | |
| | suctioning event | | | |
| | Hyperventilation | ↑respiratory rate setting | ↑RR | Associated |
| | Hyperinflation | ↑tidal volume setting | ↑Vt (Observed) | Associated |
| | Hyperinflation | Manually trigger preset sigh | ↑Vt (Observed) | Associated |
| | | breaths on mechanical | | |
| | | ventilators that are equipped | | |
| | | with a sigh feature | | |

The procedure profile comprises multiple levels of conditions for identifying procedures or protocols, where each level is ranked according to the strength of association of the rules with the profile. Each condition represents data such as a test result, diagnosis, demographic data or measurement reading for the patient at an instant of time. The top level of conditions, which are termed the “definitional level,” involves conditions that must be true for the procedure profile to apply to the set of clinical events. For example, as illustrated in Table 1, the patient must be on a mechanical ventilator and the FiO2 setting must be set to 1.0 (100% oxygen) prior to the event. If these criteria are met, a pattern match will be found.

The “associated level” presents circumstances that may be present in addition to the conditions specified at the definitional level. In the suctioning example, observing an acute increase in SpO2 that occurs simultaneously with acute increases in respiratory rate, FiO2, and tidal volume (e.g., measured as settings on a mechanical ventilator), in addition to the changes at the definitional level, provides further evidence that the suctioning procedure is being performed, as opposed to a deterioration in the patient's health status.

The “precursor level” indicates the event or series of events that signal a need to initiate the clinical procedure. In Table 1, an example is recognizing a downward trend in the dynamic lung compliance values that indicate increased labor of breathing on the patient's part, which, if left untreated, could be detrimental or fatal.

Each of these variables and ranges is coded into the procedure profile to determine whether a procedure or protocol has occurred. Fuzzy membership accounts for the fact that not all of the criteria within the procedure profile may be met. This is clinically correct since a patient does not need to have all possible variables in an abnormal range when procedures are taking place. The additional levels of conditions allow a “degree of membership” to a procedure profile that extends beyond the definitional conditions. The larger the number of definitional and associated conditions that are true for a given patient during a specified time period, the larger the degree of membership to that procedure profile. Additional levels can be included to aid inferencing for the detection of procedures and protocols.

FIG. 4 illustrates a method for real-time implementation of the procedure profiles system, in accordance with various aspects set forth herein. The following steps describe the process of implementing the procedure profiles using real- time data collection with reference to Table 2 (below), where the procedure profile is organized by level. At 90, data is aggregated from the charting database (including potential alerts identified by the clinical alerting algorithms), the ADT system, and the lab system. At 92, as each data point is received, definitional and/or precursor events defined in the procedure profiles (e.g., trends, thresholds, etc.) are identified or detected, which potentially indicate that a procedure or protocol is required or is being performed. At 94, when a match to the definitional and/or precursor levels of a procedure profile occurs, the event(s) at the associated level for that procedure profile are examined to determine whether it is probable that the procedure or protocol is being performed or has been performed. At 96, a determination is made regarding the likelihood that the identified procedure is being or has been performed. If the probability determined at 94 is greater than a predetermined threshold value (e.g., 50%, 75%, 90%, 99%, or some other predetermined probability), then the clinical record of the patient is annotated to indicate that the procedure was performed, at 98. If not, then the method continues to evaluate data aggregation. Optionally, the probability can be incorporated into the annotation. In another embodiment, the clinical caregiver is queried to confirm whether the procedure was performed. If it was performed, then the clinical record is annotated to indicate so, at 98.

Table 2 illustrates an example of a procedure profile organized by level (as opposed to time, which is shown in Table 1, above.).

TABLE 2
Endotracheal Suctioning Procedure Profile organized by Level.

| | | | Expected changes on | |
|---|---|---|---|---|
| Level | Event | Changes in equipment settings | physiological values | Stage |
| Definitional | Patient must be on | Recorded measurements that | N/A | Requirements |
| | a mechanical | indicate a patient is on a | | |
| | ventilator | ventilator, including ventilator | | |
| | | settings (ventilator mode, tidal | | |
| | | volume setting, respiratory rate | | |
| | | setting, PEEP setting, etc.), | | |
| | | ventilator start/end dates, etc. | | |
| | Hyperoxygenation | FIO2 setting set to 1.0 | ↑SpO2 or ↑SaO2 | Patient |
| | by delivery of 100% | | | preparation |
| | oxygen for >30 | | | |
| | seconds prior to | | | |
| | suctioning event | | | |
| Precursor | Increased peak | None | If volume-controlled | Precursors |
| | inspiratory | | mechanical | |
| | pressures during | | ventilation, ↑PIP | |
| | volume-controlled | | | |
| | mechanical | | | |
| | ventilation | | | |
| | Decreased tidal | None | If pressure-controlled | Precursors |
| | volume during | | mechanical | |
| | pressure-controlled | | ventilation, ↓Vt | |
| | mechanical | | | |
| | ventilation | | | |
| | Deterioration of | None | ↓PaO2 | Precursors |
| | arterial blood gas | | | |
| | values | | | |
| | Increased work of | None | ↓Cdyn or ↑airway | Precursors |
| | breathing | | resistance | |
| Associated | Hyperventilation | ↑respiratory rate setting | ↑RR | Patient |
| | | | | preparation |
| | Hyperinflation | ↑tidal volume setting | ↑Vt (Observed) | Patient |
| | | | | preparation |
| | Hyperinflation | Manually trigger preset sigh | ↑Vt (Observed) | Patient |
| | | breaths on mechanical | | preparation |
| | | ventilators that are equipped | | |
| | | with a sigh feature | | |
| | Initiation of use of | Initiation of SpO2 measurements | SpO2 measurements | Patient |
| | pulse oximeter to | that last the duration of the | recorded only for | preparation |
| | assess oxygenation | procedure | duration of | |
| | during and following | | procedure | |
| | procedure | | | |
| | Instillation of | Initiation of normal saline drip | Dosages recorded for | Patient |
| | normal saline | | normal saline | preparation |
| | through artificial | | | |
| | airway to dilute and | | | |
| | mobilize pulmonary | | | |
| | secretions | | | |
| | Hyperoxygenation | FIO2 setting set to 1.0 | ↑SpO2 or ↑SaO2 | Follow-up |
| | by delivery of 100% | | | |
| | oxygen for >60 | | | |
| | seconds prior to | | | |
| | suctioning event | | | |
| | Hyperventilation | ↑respiratory rate setting | ↑RR | Follow-up |
| | Hyperinflation | ↑tidal volume setting | ↑Vt (Observed) | Follow-up |
| | Hyperinflation | Manually trigger preset sigh | ↑Vt (Observed) | Follow-up |
| | | breaths on mechanical | | |
| | | ventilators that are equipped | | |
| | | with a sigh feature | | |

If there is a match at the precursor level, but no actions at the definitional level are taken, the system alerts the caregiver to the potential need for the specified procedure or protocol. If there is a match at the definitional level and at the associated level (and possibly at the precursor level), the caregiver is queried to determine if the procedure or protocol defined in the procedure profile is being performed on the patient. If so, then the system annotates the procedure in the database to indicate that the procedure or protocol occurred. In one embodiment, the affected values are recorded in a different color. In another embodiment, the affected values are flagged to signify the event, which can be expanded on-demand for further information by the caregiver.

If the user indicates that the procedure is not being performed on the patient, then the system suggests a clinical action to remedy the patient's deteriorating situation, and the monitored patient data is sent to the central station.

Considering the Endotracheal Suctioning Procedure Profile example of Table 2, if a patient is identified as being on a ventilator because there are current values for positive end expiratory pressure (PEEP) setting and ventilator mode (Definitional), and the FiO2 setting is changed from 0.4 to 1.0 (Definitional), and the patient's PaO2 values have been trending downward over the past 4 hours at a rate of 10 mmHg per hour (Precursor), and the tidal volume setting on the ventilator is increased at the same time as the FiO2 setting is increased (Associated), then the system queries the caregiver: “Is the patient being suctioned? Yes or No.”

In this setting, the system allows annotation of the data with no extra effort or input from the caregivers, as opposed to classical systems in which similar data would trigger a false alarm that requires acknowledgement from the caregivers. Because the system annotates the events to indicate which procedure has taken place, these notes are available on-demand for review by other caregivers. As described above, the automatic detection of these clinical events can be provided as an add-on for clinical decision support systems (e.g., as a software product stored to a computer-readable storage medium or the like).

When working with retrospective data, the system identifies a set of events that lasts for a specified time and that meets a Procedure Profile definition. This set of events can be verified manually against clinical notes by a data abstractor. The automatic annotation system aids data abstractors by automatically identifying the occurrence of procedures and protocols, which the abstractor can manually verify.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

1. A system (8) that facilitates automated annotation of clinical data, including:
a charting database (12) that includes historical patient vital sign information;
an admission-discharge-transfer (ADT) database (16) that stores patient information related to patient admission, discharge and transfer to and from healthcare facilities;
a laboratory database (18) that stores patient laboratory test result information; and
a procedure profiles system (10) with a processor (36) that executes computer-executable instructions stored in a computer-readable medium (34), the instructions including:
aggregating patient data from one or more of the charting database (12), the ADT database (16), and the laboratory database (18);
matching patterns of events in the aggregated patient data that are defined in one or more procedure profiles;
determining a probability that a clinical procedure is required, is in progress, or has been completed, as a function of the matched events;
annotating the patient's clinical record to indicate that the procedure is required or has been performed if the probability is above a predetermined threshold; and
storing the annotated patient clinical record to a computer-readable medium (36).

2. The system according to claim 1, wherein the instructions further include:
identifying at least one of a definitional event or a precursor event in the aggregated patient data that is defined in a procedure profile for the procedure, wherein the definitional or precursor event indicates that the procedure is likely to be required, in progress, or completed; and
identifying at least one associated event in the aggregated patient data that is defined in the procedure profile and that increases the probability that the procedure is required, in progress, or completed.

3. The system according to claim 1, further including:
a central station (26) at which the annotated patent clinical record is received and stored for review by a clinician.

4. The system according to claim 1, further including:
a clinical data server (22) that receives patient vital sign measurement data from one or more patient monitors (14) coupled to a patient, and provides the measurement data to the charting database (12).

5. The system according to claim 1, further including:
a configuration. database (24) that alters alarms threshold levels following a procedure in order to mitigate false alarms.

6. The system according to claim 1, wherein the processor (36) further executes instructions for generating procedure profile definitions (42), the instructions including:
identifying clinical procedures for which profiles are desired;
defining procedure profile parameters for the identified procedures;
identifying observable elements in the procedure profile parameters;
testing one or more procedure profiles using a retrospective clinical, database in order to validate the one or more procedure profiles; and
storing the one or more procedure profiles to a procedure profile database.

7. The system according to claim 6, wherein the procedure profile parameters include one or more of:
circumstances under which the procedure is employed;
equipment settings that are changed in order to perform. the procedure; and
expected impact of the procedure on patient physiological values.

8. The system according to claim 1, wherein defining procedure profile parameters includes at least one of:
hypothesizing variables and ranges of variable values that necessitate an identified clinical procedure based on published clinical practice guidelines and protocols;
identifying relevant variables that are affected by an identified clinical procedure based on analysis a patient database comprising patient data; and
performing weighted search on the procedure profile database in order no identify existing procedure profile definitions.

9. A method of automatically annotating clinical patient data, including:
aggregating patient data from one or a plurality of sources;
matching patterns of events in the aggregated patent data that are defined in one or more procedure profiles;
determining a probability that a procedure is required, is in progress, or has been completed, as a function of the identified events; and
annotating the patient's clinical record to indicate that the procedure is required or has been performed if the probability is above a predetermined threshold.

10. The method according to clam 9, wherein the procedure profiles include one or more of:
circumstances under which the procedure is employed;
equipment settings that are changed in order to perform the procedure; and
expected impact on patient physiological values.

11. The method according to claim 1, wherein defining the procedure profile includes hypothesizing variables and ranges of variable values that necessitate an identified clinical procedure based on published clinical practice guidelines and protocols.

12. The method according to claim 9, wherein defining the procedure profile includes performing weighted search on the procedure profile database in order to identify existing procedure profile definitions.

13. The method according to claim 9, further including:
aggregating the patent data from at least one of:
a charting database that includes historical patient vital sign information;
an admission-discharge-transfer database that stores patient information related to patient admission, discharge and transfer to and from healthcare facilities; and
a laboratory database that stores patient laboratory test result information.

14. The method according to claim 9, wherein determining the probability that the procedure is required, is in progress, or has been completed includes:
identifying at least one of a definitional event or a precursor event in the aggregated patient data that is defined in a procedure profile for the procedure, wherein the definitional or precursor event indicates that the procedure is likely to be required, in progress, or completed; and
identifying at least one associated event in the aggregated patient data that is defined in the procedure profile and that increases the probability that the procedure is required, in progress, or completed.

15. The method according to claim 9, further including at least one of:
storing the annotated patient clinical record to a computer-readable medium for review by a clinician; and
displaying the annotated patient clinical record to a clinician for review.

16. The method according to claim 9, further including:
adjusting alarm trigger threshold levels upon completion of the procedure to mitigate false alarms.

17. The method. according to claim 9, further including:
executing a data mining algorithm that searches patient data and matches event patterns to procedure profile definitions.

18. A computer-readable medium (36) carrying software that controls a processor to perform the method of claim 9.

19. A procedure profile system, including:
a charting database (12);
an admission/discharge/transfer (ADT) database (16);
a laboratory database (18); and
a processor (34) programmed to perform the method of claim 9.

20. A method of generating procedure profiles for annotating clinical patient data, including:
identifying clinical procedures for which profiles are desired;
defining procedure profile parameters for the identified procedures;
identifying observable elements in the procedure profile parameters;
testing one or more procedure profiles using a retrospective clinical database in order to validate the one or more procedure profiles; and
storing the one or more procedure profiles to a procedure profile database.
